(19) United States
(12) Patent Application Publication
(10) Pub. No.: US 2009/0251468 A1
(43) Pub. Date: Oct. 8, 2009

(54) ANIMATING OF AN INPUT-IMAGE TO CREATE PERSONAL WORLDS

(76) Inventor: Nachshon PELED, Moshav Beer Tuvia (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/061,699

(22) Filed: Apr. 3, 2008

(51) Int. Cl. G06T 13/00

(52) U.S. Cl. 345/473

(57) ABSTRACT

The present invention discloses a system and a method for creating a personal animated world of a user by automatically animating an input-image such as a drawing of an animal inputted by the user.

The animating is carried out by defining framing-points, which frame the input-image, and changing the size and/or the rotation angle of the framed input-image, the positioning of the image on a predefined world-space area and/or the distances between at least some of the framing-points.

### FIELD OF THE INVENTION

The present invention relates generally to the field of software tools and more particularly to animation software tools.

### BACKGROUND OF THE INVENTION

Many software tools and applications allow using electronic drawing-tools such as a mouse or an electronic pen for creating of drawings on a working board which corresponds to the movements of the drawing-tool to form the created drawing on the screen. Children, especially young children such as toddlers, are usually very fond of these tools and love using them to create their own drawings, retrieve ready-made drawings to paint those drawings and the like.

It is well known that children enjoy animations maybe since their imagination is at its peak enabling them to fully believe the reality-taking place on the screen.

Animation software tools are usually designed for professionals comprising too many option requiring a vast knowledge therefore are not designated for the use of children especially toddlers.

A patent application number WO9208201 discloses a technique for automatically producing drawings that includes hand-drawing of a group of similar images of a first type within an active area of a first sheet, scanning it with a scanner to produce corresponding run-length data, operating on the run-length data to form software objects representing the images of the first group, and storing the first software objects in a first software layer.

A U.S. Pat. No. 5,687,304 discloses a computer graphics painting system defined in terms of three-dimensional graphics and texturing mapping. A three dimensional drawing primitive, most commonly a polygonal mesh, is directed along a path specified by a tablet, mouse, or other input stream. The primitive is transformed to sequential locations along the stroke in three-dimensional space. At each location, the primitive is processed with texture mapping techniques and blended into the frame buffer for real-time display. The brush primitive may take many forms to achieve a wide variety of painting effects and styles. The polygonal mesh form may also be active in conforming to any underlying surface or model data, thus enabling real-time painting of three-dimensional objects.

A U.S. Pat. No. 5,201,011 discloses an image markup detection device and method identifies and extracts markup lines and regions marked automatically or interactively by a user with an ordinary pen or pencil. Only morphological image processing operations on a scanned source image are used, resulting in the extrapolation of markup lines and marked region. The markup lines are either extracted from the image, or the background information of the image (e.g., text) is removed, leaving only the markup lines. The marked region can then be printed, transferred or otherwise processed.

### SUMMARY OF THE INVENTION

The present invention, in some embodiments thereof, discloses a system and a method for creating a personal animated world of a user.

According to some embodiments of the invention, the system may comprise:
at least one user's terminal, which is a computerized system enabling to process and display data as well as enabling a user to input data;
a graphical user interface (GUI), comprising at least one world-space wherein said GUI enables the user to input a personal input-image and define features of a personal world to be displayed in said world-space;
an animation module enabling to animate said input-image by at least one of: rotating said input-image; and defining framing-points, which define a frame of said input-image, and continuously changing the distances between at least some of said framing-points thereby creating a movement of said input-image; and
an activities module enabling the user to define activities for said input-image and animate said input-image according to said defined activities,

According to some embodiments of the invention, each activity may be selected by the user and carried out by displaying a predefined set of postures of said input-image wherein each posture defines the rotation angle and coordinates of said input-image and the distances between said framing-points, wherein said displaying may be carried out according to predefined time-intervals between said postures' display.

According to some embodiments of the invention, the activities module and GUI may enable the user to select at least one of a predefined least of activities, where the activities may be for example running, walking, eating, giving birth and flying.

According to some embodiments of the invention, the activities module and GUI may further enable the user to select additional activities that are designated to multiple input-images such as fighting, kissing, hugging, playing together etc.

According to some embodiments of the invention, the activities module may additionally enable the user to define a time schedule to each selected activity and operate animation of said defined activity according to said defined time schedule.

According to some embodiments of the invention, the GUI, activities module and animation module may be embedded in a software application that is installed in the user's terminal.

According to some embodiments of the invention, the activities module and animation module may be embedded in a main server enabling users with users' terminals to communicate with said main server and use said GUI to create personal worlds and input-images and to share their personal worlds and input-images.

According to some embodiments of the invention, the communication between the main server and the users' terminals may be carried out through at least one communication network (e.g. the internet).

According to some embodiments of the invention, the main server may be a web server comprising a web application that comprises the activities module and animation module.

According to some embodiments of the invention, the application may further comprise a games module enabling users to play at least one embedded computer game, where at least one of the players in each game may be the user's input-image. The games module may allow the input-image to move in animation, according to the game's moves like an animated pawn or player.

According to some embodiments of the invention, the GUI may further comprise a world board comprising a general toolbar comprising at least one general-tool enabling the user at least one of: drawing an input-image and defining at least one feature of the personal world. The input-image and the world-space may be displayed and animated according to the features defined by the user using the general toolbar.

According to some embodiments of the invention, the world board may further comprise an activities toolbar comprising at least one activity related tool. The activities related tools may be at least one of: activity-type selection tool, activity scheduling tool, alarming tool. The input-image and the world-space may be displayed and animated according to the schedules and activities selected by the user using the activities toolbar.

According to some embodiments of the invention, the system may enable the user to insert a retrieved background picture.

According to some embodiments of the invention, the frame of said input-image created by the framing-points may be a polygon.

### BRIEF DESCRIPTIONS OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a block diagram, which schematically illustrates a system for creating personal animated worlds, according to some embodiments of the invention;

FIG. 2A, FIG. 2B, FIG. 2C, FIG. 2D, FIG. 2E and FIG. 2F schematically illustrate different postures of an input-image creating the animated movement, according to some embodiments of the invention;

FIG. 3 is a block diagram, which schematically illustrates a graphical user interface for creating a personal animated world, according to some embodiments of the invention;

FIG. 4 is a flowchart, which schematically illustrates a method for creating a personal animated world, according to some embodiments of the invention; and

FIG. 5 is a block diagram, which schematically illustrates a system for creating personal animated worlds enabling users to share their personal animated worlds, according to other embodiments of the invention.

The drawings together with the description make apparent to those skilled in the art how the invention may be embodied in practice.

### DETAILED DESCRIPTIONS OF SOME EMBODIMENTS OF THE INVENTION

While the description below contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

The present invention, in some embodiments thereof, discloses a method and a system 1000 for creating personal animated worlds based on at least one input-image 100. The system 1000 may allow users (especially yet not exclusively children and toddlers) to draw or import an input-image 100, which may be a creature or an animal, for example, and automatically animate the input-image 100 in a world-space 510, which is a predefined area in the display means of the system 1000.

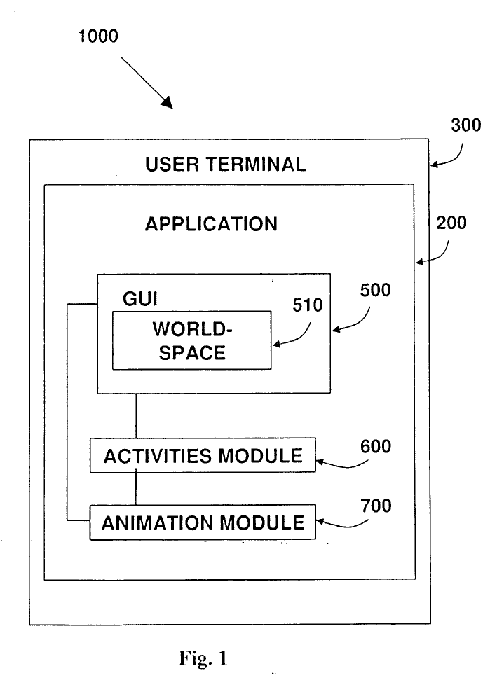

According to some embodiments of the invention, as illustrated in FIG. 1, the system 1000 for creating an animated world may comprise at least some of:
at least one user's terminal 300;
a graphical user interface (GUI) 500 comprising at least one world-space 510;
an animation module 700; and
an activities module 600.

According to some embodiments of the invention, the user's terminal 300 may be any computerized system enabling to process and display data as well as enabling a user to input data such as, for example a personal computer (PC) with a screen and input devices (E.g. keyboard, mouse etc.), laptop, a mobile phone and the like.

According to some embodiments of the invention, the GUI 500 may enable the user to input a personal input-image 100 and define features of a personal world and other features of the personal world and input-image 100 to be displayed in the world-space 510.

According to some embodiments of the invention, the world-space 510 may be any display area representing the virtual personal world. The world-space 510 may comprise features such the one or more input-images 100, a background of the input-image 100, decorative and/or active elements, which may be selectable.

According to some embodiments of the invention, the animation module 700 may enable animating the input-image 100 by for example, (i) rotating the input-image 100, (ii) changing the coordinates determining the positioning of the input-image 100 in the world-space 510, and (iii) defining framing-points 10, which define a frame of the input-image 100 and continuously changing the distances between at least some of the framing-points 10 thereby creating the animated movement of the input-image 100.

According to some embodiments of the invention, the activities module 600 may enable the user to define activities for the input-image 100 such as walking, running, eating, giving birth, flying etc. and automatically animate the input-image 100 according to the selected activities. Each selected activity may be carried out by displaying a predefined set of postures of the input-image 100 where each posture defines the rotation angle and coordinates of said input-image 100 in the world-space 510 and the distances between the framing-points of the input-image 100. The displaying of the activity may be carried out according to predefined time-intervals between the postures' display.

Additionally, the user may define a schedule to each activity, according to which the activity is activated or a reminder may appear to allow the user to activate the activity (e.g. a feeding schedule, where an eating alarm appears (aurally or visually) reminding the user to press a virtual button appearing on the world-space 510 that allows displaying an animation showing the input-image 100 eating at least one predefined or selected food).

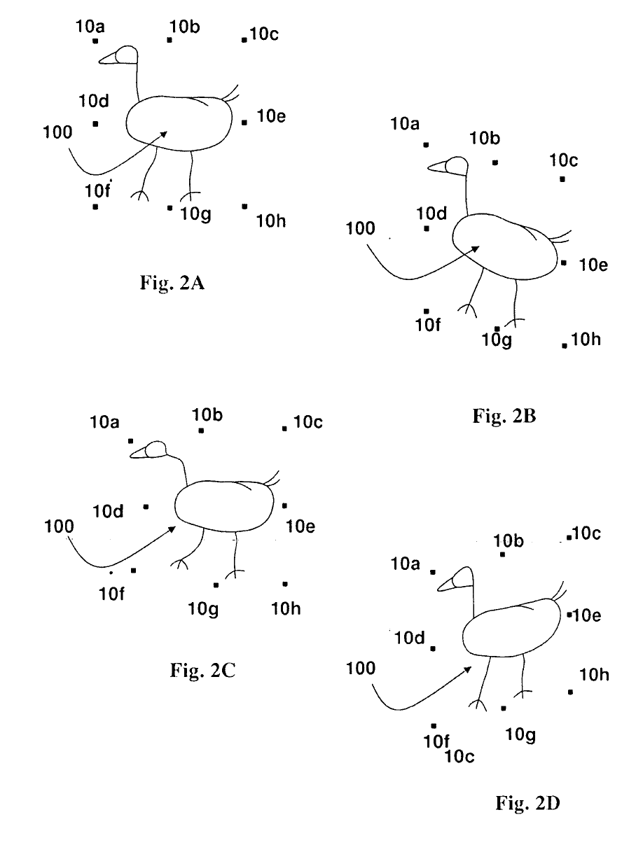

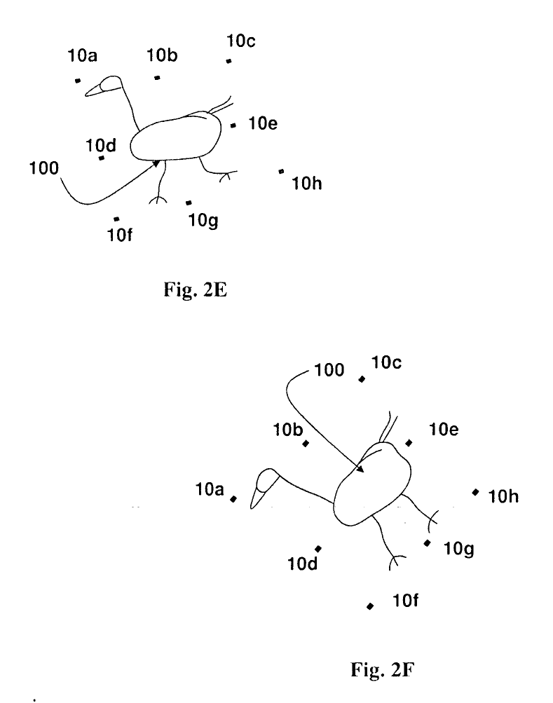

FIG. 2A, FIG. 2B, FIG. 2C, FIG. 2D, FIG. 2E and FIG. 2F schematically illustrate different postures of an input-image 100, according to some embodiments of the invention. The animated movement of the input-image 100 may be created by displaying a continuous sequence of the postures through predefined time-intervals. Once the input-image 100 is inputted by the user (e.g. by drawing an image on the world-space 510 using drawing and painting tools or by retrieving of a ready-made photographed or drawn image)—the animation module 700 may automatically define a frame by defining framing-points 10a, 10b, 10c, 10d, 10e, 10f, 10g and 10h and automatically animate the input-image 100 according to a predefined set of operations enabling the animation. This set of operations may include at least one of:
rotating the input-image 100 by rotating the frame defined by the framing-points 10a, 10b, 10c, 10d, 10e, 10f, 10g and 10h;
changing the positioning of the input-image 100 on the world-space 510 meaning changing the coordinates of the frame of the input-image 100; and
changing the distances between at least some of the framing-points 10a, 10b, 10c, 10d, 10e, 10f, 10g and 10h.
According to some embodiments of the invention, as illustrated in FIG. 2A, FIG. 2B, FIG. 2C, FIG. 2D, FIG. 2E and FIG. 2F, when the distances between the framing-points 10a, 10b, 10c, 10d, 10e, 10f, 10g and 10h is changed (e.g. enlarged or shortened) the input-image 100 may appear as moving when simultaneously changing its positioning on the world-space 510.

The framing points 10a, 10b, 10c, 10d, 10e, 10f, 10g and 10h may define a frame of any closed shape known such as a polygon where the first framing shape (before animating) is a rectangular or a square, for example.

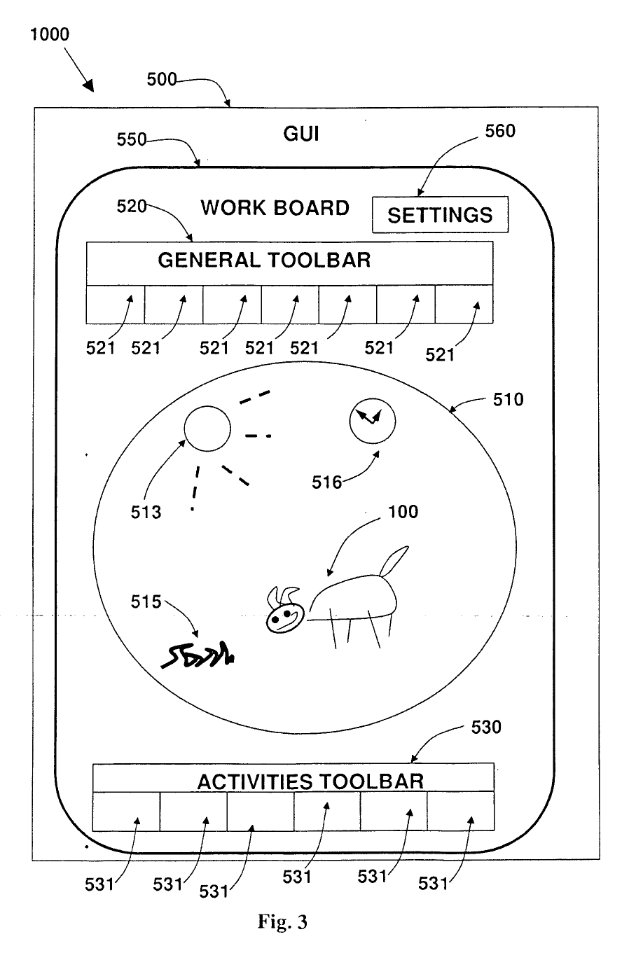

FIG. 3 is a block diagram, which schematically illustrates the graphical user interface (GUI) 500, according to some embodiments of the invention. The GUI 500 may comprise a work board 550 comprising:
a general toolbar 520 comprising general tools 521;
an activities toolbar 530 comprising activities-related-tools 531; and
settings 560.

According to some embodiments of the invention, the general toolbar's 520 may include general tools 521 such as: drawing and painting tools allowing the user to draw his/her one or more personal input-images 100 and/or background of the personal world; select features of the world such as inactive elements 513 (e.g. sun, moon, tree etc.) and active elements 513 (e.g. ready made selectable cartoons such as a smiley blinking etc.).

According to some embodiments of the invention, the activities toolbar's 530 activity-related-tools 531 may be, for example, (i) an activity-type selecting tool 531 enabling the user to view a list of activities and select an activity out of the list; (ii) a scheduling tool 531 enabling the user to set the schedules according to which each selected activity is either activated or should be activated by the user (e.g. by activating an alarming element reminding the user to activate the activity); and (iii) activity duration tool 531 enabling the user to set the duration time of the selected activity; and the like.

According to some embodiments of the invention, the activities-related-toolbar 530 may additionally comprise multiple-images 100 tools 531 enabling setting activities that can only be carried out with two or more input-images 100 (e.g. kissing, fighting, holding hands, playing together, talking etc.).

According to some embodiments of the invention, the settings 560 may enable the user to set other properties and features relating to the personal world and the input-image 100. For example, the settings 560 may allow the user to enter an advanced world options that allow animating other features additionally to animating the input-image 100.

According to some embodiments of the invention, the system 1000 and its GUI 500, activities module 600 and animation module 700 may be all embedded in a software application 200 that can be installed in the user's terminal 300.

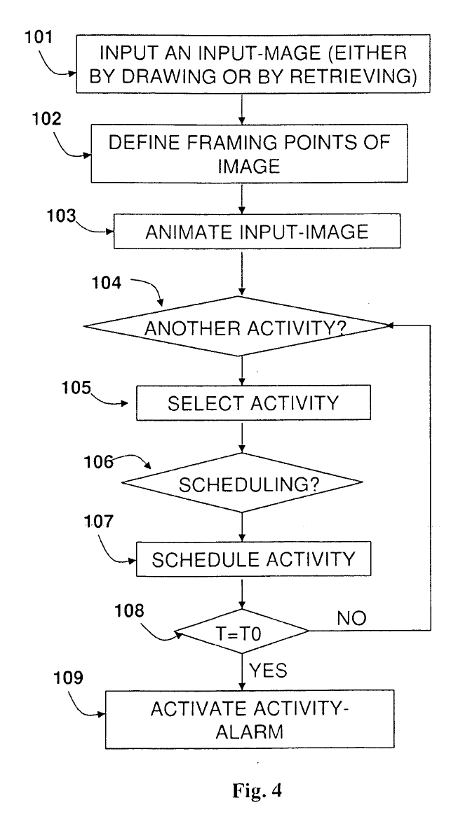

FIG. 4 is a flowchart, which schematically illustrates a method for creating a personal animated world, according to some embodiments of the invention. The method may comprise at least some of:
inputting 101 of at least one input-image 100 (either by drawing or retrieving the input-image 100);
defining 102 framing-points 10a-10h, which define the frame of the input-image;
animating 103 the input-image according to a predefined automatic animated activity (e.g. walking);
selecting an activity 104, e.g. out of a predefine list of activities;
optionally 106 scheduling 107 the activity and/or the reminder (e.g. an alarm) that reminds the user to activate the activity.

According to some embodiments of the invention, as illustrated in FIG. 4, once the activity timing arrives 108 the system 1000 may automatically activate an alarm 109 (e.g. visual alarm 516 and/or aural alarm), reminding the user that he/she has to activate the selected activity (e.g. by pressing an operation button that appears on the world-space 510.

For example, the user may select an activity out of a predefined list comprising: eating, drinking, walking, running, giving birth, flying and the like. The user may schedule at least one of the activities such as the eating activity for certain timing-parameters (e.g. 10:00, 12:00 and 19:00) when the animal has to eat. The system 1000 may automatically activate an alarm which may be the appearance of an icon representing the eating activity followed by a sound (e.g. a ring) reminding the user to press upon the icon to feed the animal. When the user presses the icon, an animation showing the input-image 100 eat (e.g. leaning downwards to a flower or a plant while parts of the plant icon gradually disappear as the animal continues eating.

According to some embodiments of the invention, the GUI 500 may also enable the user to select other parameters of each activity such as, for example, food types, drinks types, clothing, accessories and the like.

Additionally, the system 1000 may allow the user to define the personal world-related-features, such as the colors, textures and additional elements 513 of the background of the animated input-image and/or the background defining the personal-world that may be presented in the world-space 510.

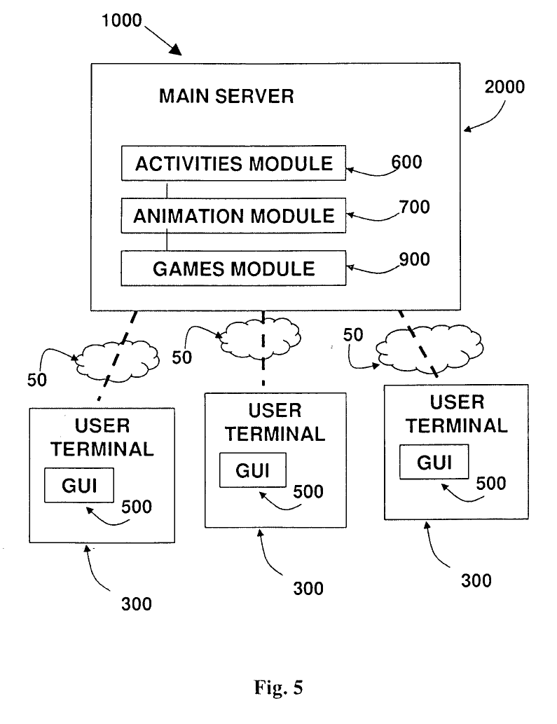

FIG. 5 schematically illustrates a system 1000 for creating personal animated worlds enabling a multiplicity of users to share at least some features of their personal worlds and at least some of their input-images 100 and activities, according to some embodiments of the invention. According to these embodiments, the activities module 600 and the animation module 700 may be supported by a main server 2000 (e.g. a web main server 2000) enabling a multiplicity of users using a multiplicity of terminals 300 to communicate with the main server 2000 through at least one communication network 50, to use the GUI 500 of the system 1000, which may enable the users to share activities, personal worlds and input-images 100. The application 200 may be running in the users' terminals 300 while the main server 2000 allows maintaining the personal worlds' features and the like.

This configuration may allow users to engage in additional activities only allowed when there is more than one player or input-image 100 (e.g. fighting, hugging, playing together and the like).

According to some embodiments of the invention, as illustrated in FIG. 5, the application 200 may additionally comprise a games module 900 enabling users to play games (e.g. ropes and ladders) where the pawn or player of each user is the user's input-image 100. The input-image 100 may be animated according to the game and its moves, by the games module 900 (e.g. walking through the grid of the game-board and falling when reaching a rope and the like).

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is:

1. A method for creating a personal animated world of a user, said method comprising:
inputting of at least one input-image 100, wherein a user inputs said input-image;
defining framing-points, which define the frame of the input-image; and
animating said input-image by changing the distances between at least some of said framing-points and rotating said input-image 100 thereby creating the movement of said input-image.

2. The method of claim 1 further comprises:
selecting at least one activity of said at least one input-image out of predefined activities, wherein each activity is carried out by displaying a predefined set of postures of said input-image wherein each posture defines the rotation angle and coordinates of said input-image and the distances between said framing-points; and
animating said input-image according to the selected activity by displaying said predefined set of postures associated with said selected activity.

3. The method of claim 2 further comprising selecting activities schedules, wherein each activity selected by the user is scheduled and wherein the input-image is animated according to each defined activity and according to the timing that has been scheduled for each said activity.

4. The method of claim 1 further comprises defining world-related-features, which allows the user to define the features of at least one of: the background of the personal world and the input-image.

5. The method of claim 4 wherein defining of said world-related-features allows the user to define at least one of: colors, textures and additional elements of the background of the animated input-image.

6. The method of claim 1 wherein inputting said input-image is carried out by drawing said input-image, wherein the user performs said drawing.

7. The method of claim 1 wherein inputting said input-image is carried out by retrieving a ready-made image, wherein the user performs said retrieving.

8. A system for creating a personal animated world of a user, said system comprising:
at least one user's terminal, which is a computerized system enabling to process and display data as well as enabling a user to input data;
a graphical user interface (GUI), comprising at least one world-space wherein said GUI enables the user to input a personal input-image and define features of a personal world to be displayed in said world-space; and
an animation module enabling to animate said input-image by at least one of: rotating said input-image; and defining framing-points, which define a frame of said input-image, and continuously changing the distances between at least some of said framing-points thereby creating a movement of said input-image.

9. The system of claim 6 further comprises an activities module enabling the user to define activities for said input-image and animate said input-image according to said defined activities,
wherein each activity is carried out by displaying a predefined set of postures of said input-image wherein each posture defines the rotation angle and coordinates of said input-image and the distances between said framing-points, wherein said displaying is carried out according to predefined time-intervals between said postures' display.

10. The system of claim 9 wherein said activities module and GUI enable the user to select at least one of a predefined least of activities, wherein said activities are at least one of: running, walking, eating, giving birth and flying.

11. The system of claim 10 wherein said activities module and GUI further enable the user to select additional activities that are designated to multiple input-images.

12. The system of claim 9 wherein said activities module further enables the user to define a time schedule to each selected activity and operate animation of said defined activity according to said defined time schedule.

13. The system of claim 9 wherein said GUI, activities module and animation module are embedded in a software application that is installed in the user's terminal.

14. The system of claim 9 wherein activities module and animation module are embedded in main server enabling users with users' terminals to communicate with said main server and use said GUI to create personal worlds and input-images and to share their personal worlds and input-images.

15. The system of claim 14 wherein said communication between the main server and the users' terminals is carried out through at least one communication network.

16. The system of claim 15 wherein said main server is a web server comprising a web application that comprises said activities module and animation module.

17. The system of claim 8 further comprises a games module enabling users to play at least one embedded computer game, wherein at least one of the players in said game is said input-image of the user and wherein said games allow the input-image to move in animation, according to the game's moves.

18. The system of claim 8 wherein said GUI further comprises a world board comprising a general toolbar comprising at least one general-tool enabling the user at least one of: drawing an input-image and defining at least one feature of the personal world;
wherein said input-image and said world-space are displayed and animated according to the features defined by the user using the general toolbar.

19. The system of claim 18 wherein said world board further comprises:
an activities toolbar comprising at least one activity related tool.

20. The system of claim 19 wherein said activities related tools are at least one of:
activity-type selection tool, activity scheduling tool and alarming tool, wherein said input-image and said world-space are displayed and animated according to the schedules and activities selected by the user using the activities toolbar.

21. The system of claim 8 enables the user to insert a retrieved background picture.

22. The system of claim 8 wherein the frame of said input-image is a polygon.
